(19) United States
(12) Patent Application Publication
(10) Pub. No.: US 2025/0193974 A1
(43) Pub. Date: Jun. 12, 2025

(54) HIGH FREQUENCY HEATING APPARATUS

(71) Applicant: Panasonic Intellectual Property Management Co., Ltd., Osaka (JP)

(72) Inventors: YOSHIHARU OOMORI, Shiga (JP); MASAYUKI KUBO, Shiga (JP)

(21) Appl. No.: 18/844,115

(22) PCT Filed: Mar. 22, 2023
(86) PCT No.: PCT/JP2023/011229

§ 371 Date: Sep. 5, 2024

(30) Foreign Application Priority Data
Mar. 30, 2022 (JP) 2022-056789

(51) Int. Cl. H05B 6/64; H05B 6/70; H05B 6/72

(52) U.S. Cl. CPC H05B 6/6447; H05B 6/705; H05B 6/72

(57) ABSTRACT

A high-frequency heating device according to the present disclosure includes a surface-wave line, a power feeder, a coupler, and a matcher. The surface-wave line propagates a surface wave. The power feeder supplies a high-frequency electric power to the surface-wave line. The coupler couples the surface-wave line to the power feeder. The matcher is disposed between the coupler and a termination of the surface-wave line. The surface-wave line includes a flow path of the high-frequency electric power, from the power feeder to the termination of the surface-wave line. The matcher extends in a direction different from the direction in which the flow path of the high-frequency electric power extends.

### TECHNICAL FIELD

The present disclosure relates to high-frequency heating devices that propagate surface waves.

### BACKGROUND ART

Patent Literature 1 discloses a high-frequency heating device for heating heating targets such as food. The heating device is provided with an adjustment means inside a waveguide for guiding a high-frequency electric power to a surface-wave exciter that propagates surface waves. According to Patent Literature 1, by carrying out impedance matching in accordance with the amount of a heating target, the maximum power from an oscillation source can be fed into the heating target.

Patent Literature 2 discloses a microwave treatment device that includes a surface-wave propagation line, a transmitter, and a matcher disposed between a surface-wave transmission line and the transmitter, the matcher which carries out impedance matching between the surface-wave propagation line and the transmitter. According to Patent Literature 2, it is possible to cancel reflected waves from the surface-wave transmission line, resulting in an efficient transmission of a high-frequency electric power.

Patent Literature 3 discloses a surface wave generator for use in a high-frequency heating device, with the surface wave generator equipped with multiple band-like upright pieces that generates surface waves. Specifically, Patent Literature 3 discloses an introduction of a plurality of surface wave generators equipped with band-like upright pieces having differences in height between at a predetermined region and at the other regions. According to Patent Literature 3, optimum heating can be carried out by varying the intensity of generated surface waves in accordance with the kind of food.

### CITATION LIST

### Patent Literature

PTL 1: Japanese Patent Unexamined Publication No. H06-338387
PTL 2: International Publication WO 2014/087666
PTL 3: Japanese Patent Unexamined Publication No. H10-41064

### SUMMARY OF THE INVENTION

With the high-frequency heating device disclosed in PTL 1, other than the high-frequency electric power propagating through a surface-wave line, another high-frequency electric power is also used that is radiated into a heating chamber. For this reason, even if the impedance is matched by means of the adjustment means in the waveguide as disclosed in PTL 1, the matching using a surface-wave line is not always able to maximize the heating.

Even with the matcher disposed as disclosed in PTL 2, it does not solve a problem of impedance mismatching caused by food placed in the middle of the surface-wave line, which will cause radiation of a high-frequency electric power and the like at the position where the food is placed. Therefore, the heating of food cannot be maximized. The matcher is disposed in series between the surface-wave propagation line and the transmitter. This makes longer the propagation distance to the surface-wave line, resulting in an increase in a high-frequency electric power radiated into a space.

In the case where multiple surface-wave lines are disposed depending on various foods as disclosed in PTL 3, it requires many surface-wave lines prepared in accordance with the kind of food. Further, these surface-wave lines may also be supposed to be used inappropriately. Therefore, the surface wave generator disclosed in PTL 3 is not suitable for practical use.

The present disclosure is to provide a high-frequency heating device that ensures its impedance matching in accordance with various foods and that thereby maximizes heating of food by means of its surface-wave line.

A high-frequency heating device according to an aspect of the present disclosure includes a power feeder, a surface-wave line, a coupler, and a matcher. The power feeder supplies a high-frequency electric power. The surface-wave line propagates the high-frequency electric power as a surface wave. The coupler couples the power feeder to the surface-wave line. The matcher is disposed between the coupler and a termination of the surface-wave line.

According to the present disclosure, it is possible to minimize radiation of a high-frequency electric power into a space, and to minimize reflected waves in the surface-wave line. Further, it is possible to ensure the impedance matching at a position suitable for maximizing the heating of a heating target by using the surface-wave line. As a result, it is possible to carry out desired heat treatments for various heating targets.

### BRIEF DESCRIPTION OF DRAWINGS

FIG. 1 is a schematic elevational view of a high-frequency heating device according to a first embodiment of the present disclosure.

FIG. 2 is a diagram illustrating mismatching points in a surface-wave line.

FIG. 3 is a schematic perspective view of matchers of the high-frequency heating device according to the first embodiment.

FIG. 4 is a diagram illustrating flow paths of high-frequency currents in the surface-wave line.

FIG. 5 is a schematic perspective view of a matcher of a high-frequency heating device according to a modified example of the first embodiment.

FIG. 6 is a schematic plan view of a surface-wave line of a high-frequency heating device according to a second embodiment of the present disclosure.

FIG. 7 is a schematic perspective view of a surface-wave line of a high-frequency heating device according to a third embodiment of the present disclosure.

### DESCRIPTION OF EMBODIMENTS

### (Underlying Knowledge Forming Basis of the Present Disclosure)

At that time when the present inventors came to embrace the idea involving the present disclosure, technologies of heating food by propagating a high-frequency electric power as a surface wave by using a surface-wave line, have been known as technologies for grilling food.

In this situation, the present inventors found a problem as follows: At multiple mismatching points that exist in a propagation path of a high-frequency electric power through a surface-wave line, there are many occurrences of radiation, power reflection, etc. Matching at a certain location is carried out aiming at minimizing reflected waves at the location, thereby maximizing the propagating power; however, this matching hardly dedicates to matching carried out at other locations.

To solve this problem, the present inventors came to find an idea, concerning the subject matter of the present disclosure, that it is desirable to carry out matching at every mismatching point.

Hereinafter, exemplary embodiments of the present disclosure will be described in detail with reference to the accompanying drawings. However, detailed descriptions of known matters and duplicate descriptions of substantially identical configurations may be omitted.

### First Exemplary Embodiment

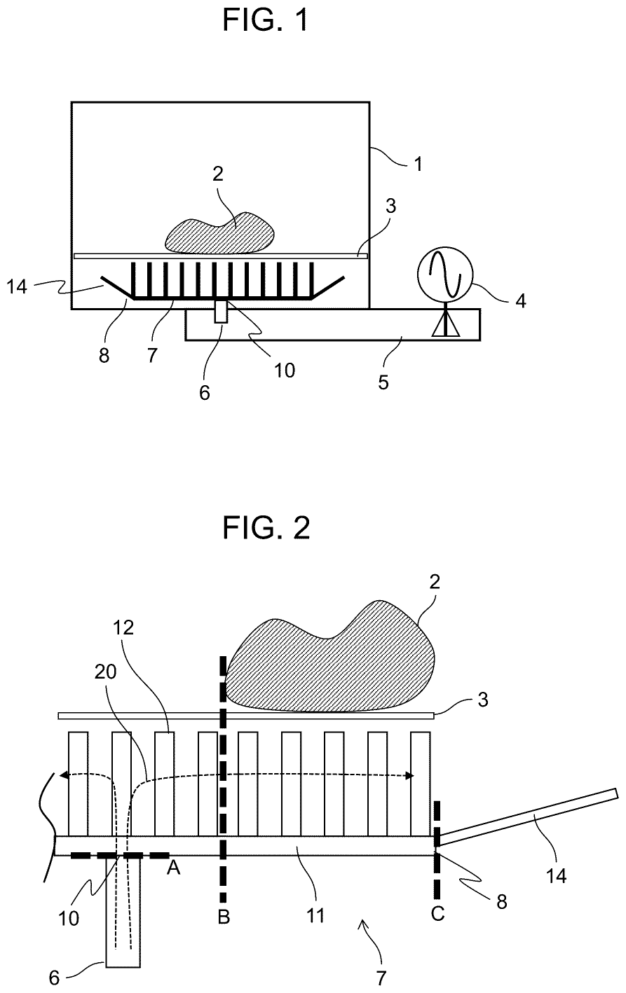

Hereinafter, referring to FIGS. 1 to 4, a high-frequency heating device according to a first exemplary embodiment of the present disclosure will be described.

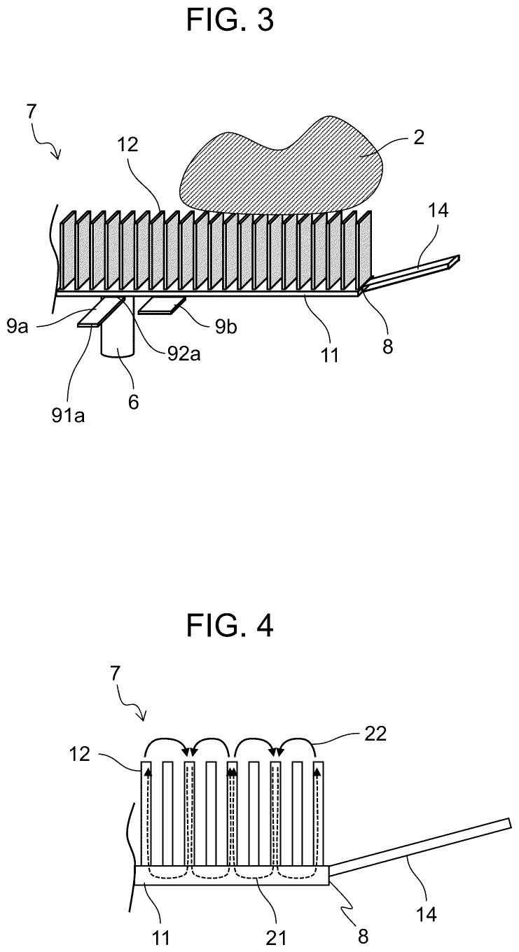

FIG. 1 is a schematic elevational view of the high-frequency heating device according to the present embodiment. FIG. 2 is a diagram illustrating mismatching points in surface-wave line 7. FIG. 3 is a schematic perspective view of a matcher of the high-frequency heating device according to the present embodiment. As shown in FIGS. 1 to 3, the high-frequency heating device according to the present embodiment includes heating chamber 1, high-frequency electric power generator 4, waveguide 5, power feeder 6, surface-wave line 7, and coupler 10.

Heating chamber 1 is a cavity for housing heating target 2, including six metal side walls and placing table 3 disposed inside the heating chamber. High-frequency electric power generator 4 is composed of either a magnetron or a semiconductor oscillator, and generates a high-frequency electric power. Waveguide 5 supplies, to power feeder 6, the high-frequency electric power generated by high-frequency electric power generator 4.

Coupler 10 couples power feeder 6 to surface-wave line 7. Power feeder 6 is a rodlike member connected to coupler 10. Power feeder 6 feeds the high-frequency electric power supplied by waveguide 5 to surface-wave line 7 via coupler 10.

Surface-wave line 7 is a stub-type surface wave exciter having a periodic structure. Surface-wave line 7 includes base conductor 11, a plurality of stub-like conductors 12, and radiator 14. Surface-wave line 7 propagates, to termination 8 as a surface wave, the high-frequency electric power having been received via coupler 10.

Base conductor 11 is a horizontal metal plate. The plurality of stub-like conductors 12 is a plurality of vertical metal plates that are periodically disposed on base conductor 11 at predetermined intervals in the propagation direction of the high-frequency electric power. Base conductor 11 includes termination 8. Termination 8 is a termination of surface-wave line 7, in a direction orthogonal to the plurality of stub-like conductors 12. Radiator 14 is disposed at termination 8.

In the plurality of stub-like conductors 12, the following configurations of them are optimized so at to allow surface-wave line 7 to sufficiently exhibit its functions: each height, each width, each thickness, their intervals, etc. As a result, surface-wave line 7 can propagate the high-frequency electric power as a surface wave without causing any radiation into heating chamber 1. The high-frequency electric power, propagated as a surface wave through surface-wave line 7, intensively heats heating target 2 placed near surface-wave line 7, which thereby gives heating target 2 a grilled burnt.

Radiator 14 is a planar antenna disposed so as to be inclined toward an above space. Radiator 14 has a length equal to a quarter of wavelength λ of the high-frequency electric power such that it can cause a resonance in the frequency band to be used, resulting in an increased radiation efficiency. Radiator 14 is coupled to the vicinity of a portion of base conductor 11 at which the high-frequency current becomes maximum. With this configuration, the high-frequency electric power that has reached termination 8 is radiated from radiator 14 into heating chamber 1, thereby dielectrically heating heating target 2.

Radiator 14 is connected to termination 8 of surface-wave line 7 and extends toward the above space. Note that surface-wave line 7 may be rotatably disposed with respect to the center axis of power feeder 6.

As shown in FIG. 2, high-frequency electric power 20 fed from power feeder 6 propagates through a plurality of stub-like conductors 12, along the path indicated by the dashed arrow in FIG. 2, to reach termination 8 of surface-wave line 7. Mismatching occurs mainly at locations where the impedance sharply changes in the propagation path of the high-frequency electric power.

Such major mismatching points in the propagation path are indicated by dashed lines A to C. The mismatching point indicated by dashed line A is at coupler 10, i.e., at the boundary between power feeder 6 and surface-wave line 7. The mismatching point indicated by dashed line C is at a location in surface-wave line 7, i.e., a position at the boundary between termination 8 and radiator 14.

The mismatching point indicated by dashed line B is at a location in surface-wave line 7, i.e., a location in the vicinity of the boundary between a section of placing table 3 with nothing being placed thereon and a section of placing table 3 with heating target 2 being placed thereon. Accordingly, the mismatching point indicated by dashed line B changes depending on where heating target 2 is placed.

To maximize the heating of heating target 2, matching must be ensured until the high-frequency electric power propagating through surface-wave line 7 reaches heating target 2; that is, the matching must be ensured either at the position indicated by dashed line A or at the position indicated by dashed line B.

When heating one piece of heating target 2, heating target 2 will usually be placed at a center portion of placing table 3. In this case, the two mismatching points indicated dashed lines A and B often coincide with each other. Therefore, at least one matcher is disposed between coupler 10 and termination 8 of surface-wave line 7.

As shown in FIG. 3, matcher 9a is disposed at the position indicated by dashed line A (see FIG. 2). Matcher 9b is disposed at the position indicated by dashed line B (see FIG. 2). Indicating a mark at a location on placing table 3 corresponding to the mismatching point indicated by dashed line B, allows a user to easily place heating target 2 near matcher 9b. Matcher 9b may be configured so as to be moved as necessary.

If matchers 9a and 9b are disposed on the side of surface-wave line 7 with the side facing heating target 2, matchers 9a and 9b possibly hinder the propagation of the surface wave. For this reason, matchers 9a and 9b are preferably disposed not on the side of surface-wave line 7 with the side facing heating target 2, but on base conductor 11 of surface-wave line 7.

Matchers 9a and 9b each have a tab shape of an elongated plate. Matchers 9a includes open end 91a and connection end 92a. Open end 91a and connection end 92a are both ends of matcher 9a in the longitudinal direction thereof. Connection end 92a is connected to a portion of base conductor 11 in the middle of the flow path (see FIG. 2) of high-frequency electric power 20. The longitudinal direction of matcher 9a is perpendicular (including substantially perpendicular) to the longitudinal direction of surface-wave line 7, i.e., perpendicular to the flow path of high-frequency electric power 20 in surface-wave line 7.

It is preferably such that the length of matcher 9a from connection end 92a to open end 91a is less than one wavelength of the high-frequency electric power, and such that the width of matcher 9a is less than a half wavelength of the high-frequency electric power. Matcher 9b is also connected to base conductor 11 as in the case of matcher 9a. Matcher 9b is connected to a portion of base conductor 11 at a further downstream position of the flow path of high-frequency electric power 20 than matcher 9a is.

With such an arrangement, it is possible to ensure an optimal matching without taking measures such as an elongation more than necessary of the power-feeding distance and an introduction of a transmission component with different performance in the middle of surface-wave line 7. This allows reflected waves in surface-wave line 7 to be minimized, resulting in an efficient transmission of the high-frequency electric power.

The material of matchers 9a and 9b is mainly a metal such as aluminum. However, the material of matchers 9a and 9b is not limited to this as long as it can provide an intended impedance at an intended location in the high-frequency transmission path.

FIG. 4 is a diagram illustrating flow paths of high-frequency currents 21 in stub-like conductors 12. FIG. 4 shows high-frequency currents 21 flowing at a certain instant through stub-like conductors 12 and base conductor 11 which both constitute surface-wave line 7.

As shown in FIG. 4, surface-wave line 7 repeatedly generates high-frequency currents 21 each of which flows in a flow path (dashed arrow of FIG. 4) from the tip of a stub-like conductor 12 through base conductor 11 to the tip of another stub-like conductor 12.

One end of each of matchers 9a and 9b is connected to a portion of base conductor 11 in the middle of the flow path of high-frequency current 21. Surface-wave line 7 propagates the high-frequency electric power as a surface wave by means of interaction between high-frequency currents 21 and electric fields 22 generated at the tips of stub-like conductors 12.

Upon putting heating target 2 near the tips of stub-like conductors 12, a change is caused in electric fields 22 near heating target 2, thereby influencing high-frequency currents 21. For this reason, even with matcher 9b disposed at the portion of base conductor 11 away from stub-like conductor 12 and placing table 3, matcher 9b exhibits its functions provided that matcher 9b is located in the flow path of high-frequency current 21.

In FIG. 2, changes in impedance are different between at the position indicated by dashed line A and at the position indicated by dashed line B. At the position indicated by dashed line A, the flow path of high-frequency current 21 runs from power feeder 6 to surface-wave line 7, along the flow of high-frequency current 21. At the position indicated by dashed line B, the flow path of high-frequency current 21 remains in surface-wave line 7, along the flow of high-frequency current 21. However, an impedance caused by heating target 2 is added to the flow path of surface-wave line 7, with the flow path running from the placing position of heating target 2 in surface-wave line 7 to termination 8.

In this way, the performance required for a matcher depends on the position where the matcher is disposed. Therefore, as shown in FIG. 3, in order to achieve their required performance, each of matchers 9a and 9b has the width, length, and shape in accordance with the disposition position of the matcher.

Specifically, increasing the length of a matcher increases the value of L-component (inductance component) of impedance of the matcher, and decreasing the length of the matcher reduces the value of L-component of impedance of the matcher. The C-component (capacitive component) of the matcher increases with increasing area of the matcher, and decreases with decreasing area of the matcher. In this way, the value of required impedance is achieved by adjusting the LC-components of impedance.

For example, the length and width of matcher 9a are set so as to ensure the matching between power feeder 6 and surface-wave line 7. The length and width of matcher 9b are set so as to ensure the matching between the following portions: a portion of surface-wave line 7 that faces a section of placing table 3 without heating target 2 placed thereon, and a portion of surface-wave line 7 that faces a section of placing table 3 with heating target 2 placed thereon.

In this way, the shape of a matcher differs depending on the impedance value of each of a plurality of objects in contact with the matcher. The present disclosure is not limited to this example, and it is sufficient if reflected waves caused by mismatching in surface-wave line 7 may be minimized by providing an intended impedance in the vicinity of the mismatching point. For example, other than the length and width of the matcher, the thickness and shape of the matcher may also be changed. Surface-wave line 7 may be combined with a plurality of components such as a dielectric one.

As shown in FIG. 2, high-frequency electric power 20 is split in left and right directions, each propagating along surface-wave line 7. In FIG. 3, illustration of high-frequency electric power 20 propagating to the left is omitted. The flow path of high-frequency electric power 20 running to the left of surface-wave line 7 is also provided with matchers as in the same manner. Coupler 10 is positioned at the location where the flow paths of the left and the right high-frequency electric power are in contact with each other, and positioned at a mismatching point common to the flow paths of the left and the right high-frequency electric power. Therefore, matcher 9a can be involved in matching in the flow paths of both the left and the right high-frequency electric power.

One end of matcher 9a is fixed to base conductor 11 such that the longitudinal direction of matcher 9a makes a predetermined angle (right angle in the embodiment) relative to the longitudinal direction of surface-wave line 7. One end of matcher 9b as well is fixed to base conductor 11 such that the longitudinal direction of matcher 9b makes a predetermined angle (right angle in the embodiment) relative to the longitudinal direction of surface-wave line 7. That is, matchers 9a and 9b are each disposed to make a predetermined angle (right angle in the embodiment) relative to the flow path of high-frequency electric power 20 in surface-wave line 7. The other end of each of matchers 9a and 9b is an open end.

In the case where surface-wave line 7 is rotated with respect to the center axis of coupler 10, surface-wave line 7 can rotate together with matchers 9a and 9b. As a result, surface-wave line 7 and matchers 9a and 9b can be oriented in a direction appropriate for matching.

In the embodiment described so far, heating target 2 is placed above surface-wave line 7 between coupler 10 and termination 8. However, as described above, when heating one piece of heating target 2, heating target 2 will usually be placed at a center portion of placing table 3.

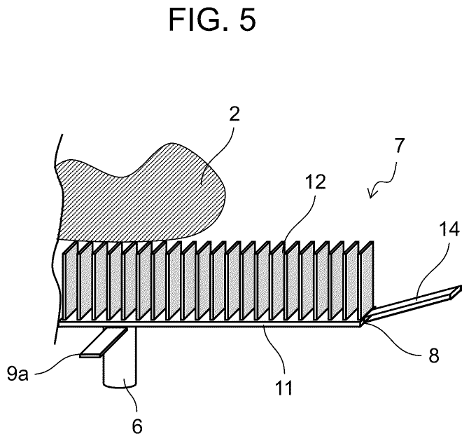

FIG. 5 is a schematic perspective view illustrating an example of a configuration of matcher 9a for dealing with this case. In this case, the two mismatching points indicated dashed lines A and B in FIG. 2 coincide with each other. Therefore, only matcher 9a may be disposed at the location indicated by dashed line A.

As described above, the high-frequency heating device according to the present embodiment includes at least one matcher (matchers 9a and 9b in FIG. 3, and matcher 9a alone in FIG. 7) disposed between coupler 10 and termination 8 of surface-wave line 7. In accordance with the present embodiment, it is possible to ensure the matching at a mismatching point, which can thereby maximize the heat treatment of heating target 2 by surface-wave line 7.

### Second Exemplary Embodiment

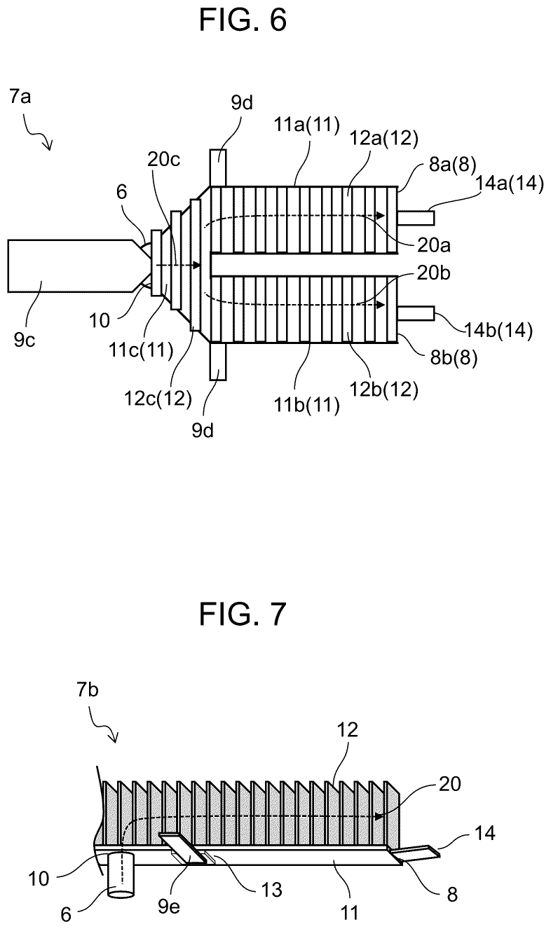

Hereinafter, a high-frequency heating device according to a second exemplary embodiment of the present disclosure will be described with reference to FIG. 6.

FIG. 6 is a schematic plan view of surface-wave line 7a of the high-frequency heating device according to the present embodiment. As shown in FIG. 6, as in the case of the first embodiment, surface-wave line 7a includes base conductor 11, a plurality of stub-like conductors 12, and radiator 14.

In the present embodiment, base conductor 11 includes base conductors 11a, 11b, and 11c. The plurality of stub-like conductors 12 includes a plurality of stub-like conductors 12a, a plurality of stub-like conductors 12b, and a plurality of stub-like conductors 12c. Radiator 14 includes radiator 14a and radiator 14b.

High-frequency electric power 20 includes high-frequency electric power 20a, 20b, and 20c. High-frequency electric power 20a propagates through the plurality of stub-like conductors 12a. High-frequency electric power 20b propagates through the plurality of stub-like conductors 12b. High-frequency electric power 20c propagates through the plurality of stub-like conductors 12c.

One end of each of base conductors 11a and 11b is connected to base conductor 11c. In other words, base conductor 11 has a V-shape as a whole when viewed from the vertical upper side. That is, surface-wave line 7a as well has a V-shape when viewed from the vertical upper side.

Base conductor 11c is a portion of base conductor 11, with the portion being connected to coupler 10. Base conductors 11a and 11b are two portions of base conductor 11, the two portions branching off from base conductor 11c. Each of base conductors 11a and 11b includes a corresponding one of terminations 8a and 8b at the end portion on the opposite side thereof from base conductor 11c. Radiators 14a and 14b are disposed at terminations 8a and 8b, respectively.

The plurality of stub-like conductors 12c is a plurality of vertical metal plates that is disposed on base conductor 11c periodically at predetermined intervals in the propagation direction of high-frequency electric power 20c. High-frequency electric power 20c branches off into high-frequency electric power 20a and high-frequency electric power 20b. High-frequency electric power 20a and 20b propagate through stub-like conductors 12a and 12b, respectively.

The plurality of stub-like conductors 12a is a plurality of vertical metal plates that is disposed on base conductor 11a periodically at predetermined intervals in the propagation direction of high-frequency electric power 20a. The plurality of stub-like conductors 12b is a plurality of vertical metal plates that is disposed on base conductor 11b periodically at predetermined intervals in the propagation direction of high-frequency electric power 20b.

High-frequency electric power 20a reaches radiator 14a via stub-like conductors 12a and termination 8a. High-frequency electric power 20b reaches radiator 14b via stub-like conductors 12b and termination 8b. Radiators 14a and 14b radiate high-frequency electric power 20a and 20b into heating chamber 1, respectively.

In the propagation paths of high-frequency electric power 20a, 20b, and 20c shown in FIG. 6, major mismatching points are at the positions as follows: coupler 10, the branching point of surface-wave line 7a, a part of the placing position of heating target 2 with the part closest to coupler 10 (see FIG. 2), and terminations 8a and 8b.

In order to maximize the heating of heating target 2, the matching is preferably ensured at the following positions among the positions described above: the branching point of surface-wave line 7a, and a part of the placing position of heating target 2 with the part closest to coupler 10.

Surface-wave line 7a includes matcher 9c and two matchers 9d. Matcher 9c is disposed at, among the mismatching points described above, a part of the placing position of heating target 2 with the part closest to coupler 10. One of two matchers 9d is connected to a corresponding one portion of the branching point of surface-wave line 7a, i.e., connected to the boundary between base conductor 11c and base conductor 11a, and extends in the direction on the opposite side from base conductor 11b. The other of two matchers 9d is connected to the other portion of the branching point of surface-wave line 7a, i.e., connected to the boundary between base conductor 11c and base conductor 11b, and extends in the direction on the opposite side from base conductor 11a.

In the case where the branching point of surface-wave line 7a is close to the placing position of heating target 2 in surface-wave line 7a, only matcher 9d may be disposed at each of base conductors 11a and 11b.

In the case where surface-wave line 7a has an asymmetrical configuration with respect to power feeder 6, the weight balance of surface-wave line 7a is poor with respect to the center axis of power feeder 6, which makes it difficult to keep surface-wave line 7a horizontal. Such an asymmetrical configuration of surface-wave line 7a with respect to power feeder 6, means that surface-wave line 7a has a point-asymmetric shape with respect to the center axis of power feeder 6 when viewed from the vertical upper side.

In this case, when rotating surface-wave line 7a with respect to the center axis of power feeder 6, it generates a force that hinders smooth rotation. To reduce the force, matcher 9c is disposed in a direction in which the weight balance is improved with respect to power feeder 6, and preferably disposed in a direction in which a proper weight balance is attained. In the embodiment, matcher 9c extends in a direction opposite to the direction in which base conductors 11a to 11c extend.

Matcher 9c includes a tapered end portion disposed on the connecting side of matcher 9c to the flow path of high-frequency electric power 20, that is, on the closer side of matcher 9c to base conductor 11c. This makes smaller in size the connection point between matcher 9c and base conductor 11c, which in turn makes clear the location of the matching.

### Third Exemplary Embodiment

Hereinafter, a high-frequency heating device according to a third exemplary embodiment of the present disclosure will be described with reference to FIG. 7.

FIG. 7 is a schematic perspective view of surface-wave line 7b of the high-frequency heating device according to the present embodiment. As shown in FIG. 7, surface-wave line 7b includes matcher 9e disposed at base conductor 11 between coupler 10 and termination 8. Matcher 9e is in structurally non-contact with the back surface of base conductor 11 via insulator 13, and is electrically coupled to the back surface.

Matcher 9e is fixed structurally to insulator 13. Insulator 13 is connected to base conductor 11, being movable along the back surface of base conductor 11. That is, matcher 9e is connected to surface-wave line 7b so as to be able to move on surface-wave line 7b. As a result, it is possible to ensure the matching at a position depending on the putting position and the like of heating target 2.

Note that the position of heating target 2 may be detected with either an imaging unit or a sensor. In response to the detected position, matcher 9e may automatically move to an optimal position. Examples of the material of insulator 13 includes Teflon (registered trademark).

### (Configuration and Effects)

A high-frequency heating device according to a first aspect of the present disclosure includes a power feeder (6), a surface-wave line (7; 7a; 7b), a coupler (10), and a matcher (9a, 9b; 9c, 9d; 9e).

The power feeder (6) supplies a high-frequency electric power (20; 20a, 20b, 20c; 20). The surface-wave line (7; 7a; 7b) propagates the high-frequency electric power as a surface wave, the surface-wave line having a termination. The coupler (10) couples the power feeder (6) to the surface-wave line (7; 7a; 7b). The matcher (9a, 9b; 9c, 9d; 9e) is disposed between the coupler (10) and the termination (8; 8a, 8b) of the surface-wave line (7; 7a; 7b).

According to the aspect, it is possible to ensure the matching at an optimal position in the vicinity of the location where mismatching occurs, which allows the maximization of heating of a heating target by the surface wave. As a result, it is possible to carry out desired heat treatments for various heating targets.

In the high-frequency heating device according to a second aspect of the present disclosure, in addition to the first aspect, the surface-wave line (7; 7a; 7b) may have a flow path of the high-frequency electric power (20; 20a, 20b, 20c; 20), the flow path extending from the power feeder (6) to the termination (8; 8a, 8b) of the surface-wave line (7; 7a; 7b). The matcher (9a, 9b; 9c, 9d; 9e) may extend in a direction different from the direction in which the flow path of the high-frequency electric power (20; 20a, 20b, 20c; 20) extends.

According to the aspect, it is possible to ensure an optimal matching without taking measures such as an elongation more than necessary of the power-feeding distance and an introduction of a transmission component with different performance in the middle of the surface-wave line. As a result, it is possible to carry out desired heat treatments for various heating targets.

The high-frequency heating device according to a third aspect of the present disclosure may further include, in addition to the first or second aspect, a radiator (14; 14a, 14b; 14) connected to the termination (8; 8a, 8b) of the surface-wave line (7; 7a; 7b) and disposed so as to extend toward an above space.

According to the aspect, it is possible to minimize reflected waves in the surface-wave line and to carry out reliable matching by means of the matcher, allowing efficient heat treatments of heating targets. Further, the minimizing of the reflected waves reduces the occurrence of standing waves in surface-wave line 7. This can improve uneven heating.

In the high-frequency heating device according to a fourth aspect of the present disclosure, in addition to any one of the first to third aspects, the matcher (9a, 9b; 9c, 9d; 9e) may be connected to a flow path of a high-frequency current (21) in the surface-wave line (7; 7a; 7b). According to the aspect, it is possible to ensure the matching for the high-frequency electric power propagating as a surface wave. This can maximize the heating by the surface wave.

In the high-frequency heating device according to a fifth aspect of the present disclosure, in addition to the fourth aspect, the surface-wave line (7; 7a; 7b) may include a base conductor (11; 11a, 11b, 11c; 11), and a plurality of stub-like conductors (12; 12a, 12b, 12c) disposed on the base conductor (11; 11a, 11b, 11c; 11). The matcher (9a, 9b; 9c, 9d; 9e) may be connected to the base conductor (11; 11a, 11b, 11c; 11).

According to the aspect, it is possible to ensure the matching for the high-frequency electric power propagating as a surface wave. This can maximize the heating by the surface wave.

In the high-frequency heating device according to a sixth aspect of the present disclosure, in addition to any one of the first to fourth aspects, the matcher (9a, 9b; 9c, 9d; 9e) may be disposed at one or both of the coupler (10) and a placing position of the heating target (2) at the surface-wave line (7; 7a; 7b). In accordance with the aspect, it is possible to ensure the matching at a position in the vicinity of the location where mismatching occurs in the surface-wave line, which allows the maximization of the heating by the surface wave.

The high-frequency heating device according to a seventh aspect of the present disclosure includes, in addition to any one of the second to fourth aspects, a plurality of flow paths of the high-frequency electric power (20a, 20b). Each of the plurality of flow paths of the high-frequency electric power (20a, 20b) is identical to the flow path of the high-frequency electric power (20a, 20b) described above. The matcher (9d) may be disposed in each of the plurality of flow paths of the high-frequency electric power (20a, 20b).

In accordance with the aspect, it is possible to ensure the matching at a position in the vicinity of the location where mismatching occurs in the surface-wave line, which allows the maximization of the heating by the surface wave.

The high-frequency heating device according to an eighth aspect of the present disclosure includes, in addition to any one of the second to fourth aspects, a plurality of flow paths of the high-frequency electric power (20a, 20b). Each of the plurality of flow paths of the high-frequency electric power (20a, 20b) is identical to the flow path of the high-frequency electric power (20) described above. The matcher (9d) may be disposed in a location at which the plurality of flow paths of the high-frequency electric power (20a, 20b) is in contact with each other.

According to the aspect, the one-piece matcher makes it possible to ensure matching the plurality of flow paths of the high-frequency electric power. This allows a reduction in the number of components, thereby reducing the weight and cost of the antenna.

In the high-frequency heating device according to a ninth aspect of the present disclosure, in addition to the eighth aspect, the coupler (10) may be disposed at a location at which the plurality of flow paths of the high-frequency electric power (20a, 20b) is in contact with each other. According to the aspect, a one-piece matcher makes it possible to ensure matching the plurality of flow paths of the high-frequency electric power. This allows a reduction in the number of components, thereby reducing the weight and cost of the antenna.

In the high-frequency heating device according to a tenth aspect of the present disclosure, in addition to any one of the second to fourth aspects, the matcher (9a, 9b; 9c, 9d; 9e) may have a tab shape of a plate. One end of the matcher (9a, 9b; 9c, 9d; 9e) may be connected to the flow path of the high-frequency electric power (20; 20a, 20b, 20c; 20). The other end of the matcher (9a, 9b; 9c, 9d; 9e) may be an open end.

According to the aspect, it is possible to ensure an optimal matching without taking measures such as an elongation more than necessary of the power-feeding distance and an introduction of a transmission component with different performance in the middle of the surface-wave line.

In the high-frequency heating device according to an eleventh aspect of the present disclosure, in addition to the tenth aspect, the matcher (9a, 9b; 9c, 9d; 9e) may be disposed at a predetermined angle relative to the flow path of the high-frequency electric power (20; 20a, 20b, 20c; 20) in the surface-wave line (7; 7a; 7b). According to the aspect, it is possible to ensure an optimal matching without taking measures such as an elongation more than necessary of the power-feeding distance and an introduction of a transmission component with different performance in the middle of the surface-wave line.

In the high-frequency heating device according to a twelfth aspect of the present disclosure, in addition to the tenth aspect, the matcher (9a, 9b; 9c, 9d; 9e) may have a shape of a plate having a width and length both of which are configured in accordance with the disposition position of the matcher (9a, 9b; 9c, 9d; 9e). According to the aspect, it is possible to ensure an optimal matching.

In the high-frequency heating device according to a thirteenth aspect of the present disclosure, in addition to the tenth aspect, the matcher (9c) may have a tapered end portion disposed on the connecting side of the matcher (9c) to the flow path of the high-frequency electric power (20c). According to the aspect, the limited location of the matching makes clear where the matching location is.

In the high-frequency heating device according to a fourteenth aspect of the present disclosure, in addition to any one of the second to fourth aspects, the matcher (9e) may be in structurally non-contact with the surface-wave line (7b) and may be electrically coupled to the flow path of the high-frequency electric power (20). The matcher (9e) may be connected to the surface-wave line (7b) movably on the surface-wave line (7b). According to the aspect, it is possible to ensure the matching at a position depending on the placing position and the like of a heating target.

In the high-frequency heating device according to a fifteenth aspect of the present disclosure, in addition to the fourteenth aspect, the matcher (9e) may be fixed to the surface-wave line (7b) via an insulator (13). According to the aspect, it is possible to ensure the matching at a position depending on the placing position and the like of a heating target.

In the high-frequency heating device according to a sixteenth aspect of the present disclosure, in addition to any one of the first to fourth aspects, the surface-wave line (7; 7a; 7b) may be rotatable with respect to the center axis of the power feeder (6). The matcher (9a, 9b; 9c, 9d; 9e) may be rotatable together with the surface-wave line (7; 7a; 7b). According to the aspect, it is possible to orient the surface-wave line together with the matcher in a direction appropriate for matching.

In the high-frequency heating device according to a seventeenth aspect of the present disclosure, in addition to the sixteenth aspect, in the case of the surface-wave line (7a) having an asymmetrical configuration with respect to the power feeder (6), the matcher (9c) may be disposed in a direction in which a weight balance of the surface-wave line (7a) is improved with respect to the power feeder (6). According to the aspect, it is possible to easily rotate the surface-wave line. As a result, it is possible to carry out desired heat treatments for various heating targets.

### INDUSTRIAL APPLICABILITY

The high-frequency heating device according to the present disclosure is applicable to cooking appliances.

### REFERENCE MARKS IN THE DRAWINGS

1 heating chamber
2 heating target
3 placing table
4 high-frequency electric power generator
5 waveguide
6 power feeder
7, 7a, 7b surface-wave line
8, 8a, 8b termination
9a, 9b, 9c, 9d, 9e matcher
10 coupler
11, 11a, 11b, 11c base conductor
12, 12a, 12b, 12c, stub-like conductor
13 insulator
14, 14a, 14b radiator
20, 20a, 20b, 20c high-frequency electric power
21 high-frequency current
22 electric field
91a open end
92a connection end

1. A high-frequency heating device, comprising:
a power feeder configured to supply a high-frequency electric power;
a surface-wave line configured to propagate the high-frequency electric power as a surface wave, the surface-wave line having a termination;
a coupler coupling the power feeder to the surface-wave line; and
a matcher disposed between the coupler and the termination of the surface-wave line.

2. The high-frequency heating device according to claim 1,
wherein the surface-wave line includes a flow path of the high-frequency electric power, the flow path extending from the power feeder to the termination of the surface-wave line, and
wherein the matcher extends in a direction different from a direction in which the flow path of the high-frequency electric power extends.

3. The high-frequency heating device according to claim 1, further comprising
a radiator connected to the termination of the surface-wave line and disposed so as to extend toward an above space.

4. The high-frequency heating device according to claim 1, wherein the matcher is connected to a flow path of a high-frequency current in the surface-wave line.

5. The high-frequency heating device according to claim 4,
wherein the surface-wave line includes
a base conductor, and
a plurality of stub-like conductors disposed on the base conductor, and
wherein the matcher is connected to the base conductor.

6. The high-frequency heating device according to claim 1, wherein the matcher is disposed at one or both of the coupler and a placing position of a heating target at the surface-wave line.

7. The high-frequency heating device according to claim 2,
wherein the surface-wave line includes a plurality of flow paths of the high-frequency electric power, each flow path identical to the flow path of the high-frequency electric power, and
wherein the matcher is disposed in each of the plurality of flow paths of the high-frequency electric power.

8. The high-frequency heating device according to claim 2,
wherein the surface-wave line includes a plurality of flow paths of the high-frequency electric power, each flow path identical to the flow path of the high-frequency electric power, and
wherein the matcher is disposed at a location at which the plurality of flow paths of the high-frequency electric power is in contact with each other.

9. The high-frequency heating device according to claim 8, wherein the coupler is disposed at a location at which the plurality of flow paths of the high-frequency electric power is in contact with each other.

10. The high-frequency heating device according to claim 2,
wherein the matcher includes a tab shape of a plate, and
wherein one end of the matcher is connected to the flow path of the high-frequency electric power and the other end of the matcher is an open end.

11. The high-frequency heating device according to claim 10, wherein the matcher is disposed at a predetermined angle relative to the flow path of the high-frequency electric power in the surface-wave line.

12. The high-frequency heating device according to claim 10, wherein the matcher includes a shape of a plate having a width and a length both of which are configured in accordance with a disposition position of the matcher.

13. The high-frequency heating device according to claim 10, wherein the matcher includes a tapered end portion disposed on a closer side of the matcher to the surface-wave line.

14. The high-frequency heating device according to claim 2,
wherein the matcher is in structurally non-contact with the surface-wave line and is electrically coupled to the flow path of the high-frequency electric power, and
wherein the matcher is connected to the surface-wave line movably on the surface-wave line.

15. The high-frequency heating device according to claim 14, wherein the matcher is fixed to the surface-wave line via an insulator.

16. The high-frequency heating device according to claim 1, wherein the surface-wave line is rotatable around a center axis of the power feeder and the matcher is rotatable together with the surface-wave line.

17. The high-frequency heating device according to claim 16,
wherein the surface-wave line includes an asymmetrical configuration with respect to the power feeder, and
wherein the matcher is disposed in a direction in which a weight balance of the surface-wave line is improved with respect to the power feeder.
